(19) United States
(12) Patent Application Publication
(10) Pub. No.: US 2021/0196543 A1
(43) Pub. Date: Jul. 1, 2021

(54) PATIENT LIFT DEVICE AND METHOD

(71) Applicant: Handicare Canada Ltd., Concord (CA)

(72) Inventors: Francois Roblin, (SE); Habib Abbasi, Milton (CA); Akash Pabbi, VIII, Brampton (CA); Aliasgar Morbi, Ottawa (CA); Richard Beranek, Ottawa (CA); Rohan Thakar, Ottawa (CA); Sahil Nikumbh, I, Woodbridge (CA)

(73) Assignee: Handicare Canada Ltd., Concord, ON (CA)

(21) Appl. No.: 17/056,692

(22) PCT Filed: May 17, 2019
(86) PCT No.: PCT/IB2019/000741

§ 371 Date: Nov. 18, 2020

(30) Foreign Application Priority Data
May 18, 2018 (CA) 3005407

(51) Int. Cl. A61G 7/10

(52) U.S. Cl. CPC A61G 7/1015; A61G 7/1051; A61G 7/1065

(57) ABSTRACT

A patient lift for lifting and lowering a patient. Cable or rope may be used as the lifting element. The spool winds the lifting element in successive adjacent winds. The operator lifts the patient by pushing up on the carry bar, patient or lifting element, and lowers the patient by pushing down on such elements. The lift includes automatic loading and unloading for transition on or off the bed.

### FIELD OF THE INVENTION

This invention relates generally to the field of mobility devices, and more particularly, to personal lift devices of the type that may be used to raise or lower a physically disabled person for the purpose of moving that person.

### BACKGROUND OF THE INVENTION

Personal lift or patient lift devices have been known and used in the past to assist with the mobility of otherwise immobilized or mobility-limited patients. An attendant may help a physically disabled patient who may have suffered a traumatic injury, stroke, or some other illness or condition, and who is unable to move about without assistance. However, sometimes, such patients may be too heavy to lift, or the manual lifting can result in injuries to caregivers, or the attendant may not have enough strength to help the patient move without a mechanical assistive device such as a personal lift. This issue can be especially acute for disabled patients who have reduced mobility but otherwise normal bodily functions. Getting up and going to the bathroom to use the toilet or have a bath, for example, can be difficult or impossible for such patients.

Personal lift devices that have been used in the past typically include a strap hanging down from a motor assembly, which motor assembly may be suspended from a rail carriage riding along an overhead track. The strap is wound and unwound by means of a motorized spool, and the motor may be controlled by a handheld controller. An overhead track can be organized to extend from above a bed into, for example, an adjoining bathroom area, to permit the patient to be raised, suspended, and then moved along the track to a position where the patient can be lowered into the bathtub for the purposes of a bath, or onto a toilet. Alternatively, in more compact systems, the rail may be long enough only to move the patient from the bed to, for example, a wheelchair adjacent to the bed.

Typically, the aforementioned strap is connected to a carry bar carrying a patient harness. The patient is strapped into the harness and the harness is connected to lift carry bar. When the lift is actuated, the strap pulls the bar upward which pulls the harness upward, thus lifting the patient. To lower the patient, the strap is extended downward until the patient reaches the desired surface (e.g. bed, wheelchair, toilet, bathtub), at which point the harness may be removed from patient.

There are both motorized and manual lifts. In a motorized lift, the strap is raised (typically by being wound on a spool) or extended (i.e. lowered by being unwound) by means of an electric motor rotating the spool. Typically, a wired or wireless hand-held controller is used to operate the motor to raise or lower the patient. In non-motorized lifts, the raising and lowering of the patient is done manually by the operator of the lift. For example, a chain operatively connected to the spool can be used, so that when the chain is pulled in one direction, the patient is lifted, and when it is pulled in the other direction, the patient is lowered.

In motorized lifts, lateral movement of the lift along the overhead track may also be motorized. Thus, the operator would, for example, push a particular button on a hand-held controller to cause the lift to move laterally in one or the other direction along the track

### SUMMARY OF THE INVENTION

According to an aspect of the invention, there is provided a patient lift device for lifting and lowering a patient, the lift device comprising a motor assembly including a motor for generating lifting force, a harness for holding the patient, and a lifting element operatively connected to the motor and the harness, the motor assembly further comprising a spool operatively connected to the motor for winding and unwinding the lifting element to lift and lower the patient, the spool and lifting element being configured so that as the lifting element is wound on the spool, successive winds are positioned on the spool adjacent to one another. The lifting element may comprise metal wire. The lifting element may comprise fibre rope.

According to another aspect of the invention, there is provided a patient lift device for lifting and lowering a patient, the lift device comprising a motor assembly, a lifting element operatively connected to the motor assembly, and a harness operatively connected to the lifting element for holding the patient to be lifted and lowered, the lifting element and harness defining a load path along which a patient lift load is transmitted to the motor assembly, the device further including a load sensor along the load path configured to sense the load on the motor assembly, the device further including a controller, operatively connected to the load sensor and the motor assembly, for controlling the motor assembly, and for using an output from the sensor to cause the motor to lift the patient when an operator exerts an upward force on the patient or on the load path so as to reduce the sensed load, and to lower the patient when the operator exerts a downward force on the patient or on the load path so as to increase the sensed load. The load sensor may be a single load sensor. The device may further include a carry bar, to which the lifting element is connected, which carries the harness, the carry bar being positioned on the load path, the load sensor being positioned on the carry bar. Optionally, the controller is further configured to initiate an automatic loading sequence when the lift is in a transition state between the patient fully resting on a surface and the patient being fully suspended, the automatic loading sequence comprising the lift automatically moving up regardless of haptic input to cause the patient to be fully suspended. Optionally, the controller is further configured to initiate an automatic unloading sequence when the lift is in a transition state between the patient fully resting on the surface and the patient being fully suspended, the automatic unloading sequence comprising the lift automatically moving down regardless of haptic input to cause the patient to be fully resting on a surface.

Optionally, the controller further comprises a controller for identifying a force profile associated with repositioning of a patient, and for initiating automatic repositioning loading to turn the patient on the patient's side. Optionally, the controller further comprises a controller for initiating automatic repositioning unloading to rest the patient who has been turned on the patient's side on a patient resting surface.

Optionally, the patient lift comprises harness imbalance detection for detecting unsafe coupling of the harness to the lifting element. Optionally, the harness imbalance detection comprises the load sensor. Optionally, the harness imbalance detection comprises a second sensor for detecting angling of the carry bar, which second sensor may be a visual sensor.

### BRIEF DESCRIPTION OF THE DRAWINGS

Reference will now be made, by way of example only, to preferred embodiments of the invention, by reference to the following drawings, in which:

FIG. 1 shows a spool and wound strap in a patient lift;

FIG. 2 shows a patient lift carrying a patient;

FIG. 3 shows a spool winding a lifting element; and

FIG. 4 shows an alternative lifting element winding system.

### DETAILED DESCRIPTION OF THE PREFERRED EMBODIMENTS

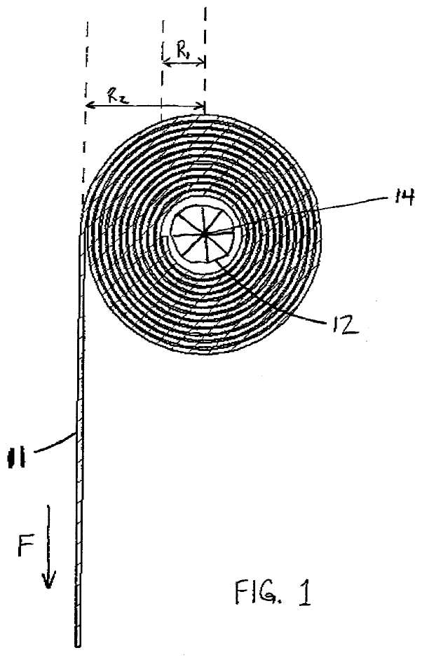

In a typical lift, the spool winds the strap in a spiral configuration. In other words, starting from full extension, as the spool winds the strap to lift the patient, the strap is being wound on top of itself, with the diameter of the wound portion of the strap thus becoming progressively thicker as the patient is lifted further. This configuration is shown in FIG. 1, which is a cross-sectional view of a strap 11 wound on a spool 12 having a cross-sectional centre point 14. R₁ and R₂ are thicknesses of the spool and wound strap at different points, and are shown as perpendicular to the portion of the strap extending down to the patient.

The present inventors have noted that this configuration has certain disadvantages. First, the winding of the strap takes up a lot of space. In order for the strap to have adequate strength to lift and lower patients repeatedly, it has to be both wide and thick, and at the same time has to have a minimum strap length to accommodate lifting to and from various ceiling heights. Thus, a spool requires substantial space in order to accommodate a fully wound or mostly-wound strap. The space requirement for the spool is crucial as it directly affects the overall height of a ceiling lift, which directly affects the usability of a ceiling lift in low height ceiling environments.

Second, the amount of power required of the motor is proportional to the distance between the center of the spool shaft and the outermost point on the spool winding (i.e. the size of R). In other words, torque is equal to the cross product of radius and force. Thus, as the patient is raised, and the thickness of the strap winding increases, the load on the motor raising the patient can increase dramatically. This can be seen in FIG. 1, where the torque necessary to overcome the load of the patient is R₂×F, where F is the gravitational force exerted by the patient, and where R₂ is greater than R₁. When more of the strap is extended, and the radius is smaller (e.g. R₁), the torque needed is R₁×F. Sometimes, near the top of the lifting range, the load on the motor can be twice or three times as large as it is near the bottom of the lifting range—depending on the thickness of the strap. Thus, much power is required, and the repeated fluctuating loads cause the motor to wear.

Third, the strap typically extends out of the motor assembly through a slot having the same long, thin shape as the cross-section of the strap. This slot shape is configured to keep the strap from twisting and tangling as the strap is extended and retracted to lower and lift the patient. Sometimes, the patient is not positioned directly below the motor assembly and the strap slot when the patient needs to be lifted. In such a situation, the strap extends diagonally downward from the motor assembly to the carry bar. In such a case, when the patient is lifted, the strap rubs against the edge of the slot as it is retracted, thus causing the strap to fray over time. A frayed strap is not only unsafe, but it is also costly to replace frequently.

Fourth, in the scenario described immediately above, the patient, once clear of the surface that he/she was resting on, will tend to swing because the strap is pulling him/her diagonally upward, and the force of gravity will operate to cause the patient to swing sideways. This can be uncomfortable, and even unsafe, for the patient.

Fifth, whether in motorized or unmotorized configurations, it is often difficult for the patient lift operator (usually a caregiver) to keep his/her hands on the patient as the patient is being lifted. In unmotorized configurations one or both of the caregiver's hands will be engaged in providing the energy to lift or lower the patient. In motorized configurations, at least one of the caregiver's hands is used to actuate the motor using be hand-held controller.

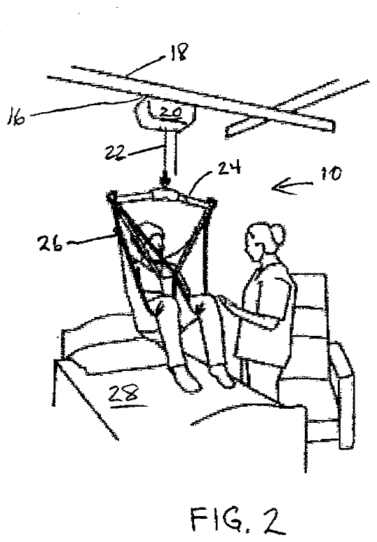

In the preferred embodiment of the invention (see for example FIG. 2), the lift 10 comprises a carriage 16 mounted to an overhead track 18. Mounted to the carriage is a motor assembly 20—preferably comprising an electric motor—that rotates a spool to wind (retract) or unwind (extend) a lifting element 22, such as, for example, a cable, which cable might be wire, rope or some other kind of cable. The lifting element is attached to a carry bar 24, which is attached to a patient harness 26. To lift the patient of the patient surface (typically bed 28), the patient is fastened into the harness, and the spool is turned so as to wind, and thus retract, the lifting element to lift the patient.

In the preferred embodiment of the invention, the lift is configured so as to prevent the rapid increase in diameter of the spool as the lifting element is wound up to lift the patient. For example, in one configuration, the spool is sized and shaped to wind the cable so that each successive wind in positioned on the spool adjacent to, rather than on top of, the previous wind. Preferably, the spool shaft is shaped so as to guide each successive wind to a position adjacent the previous wind.

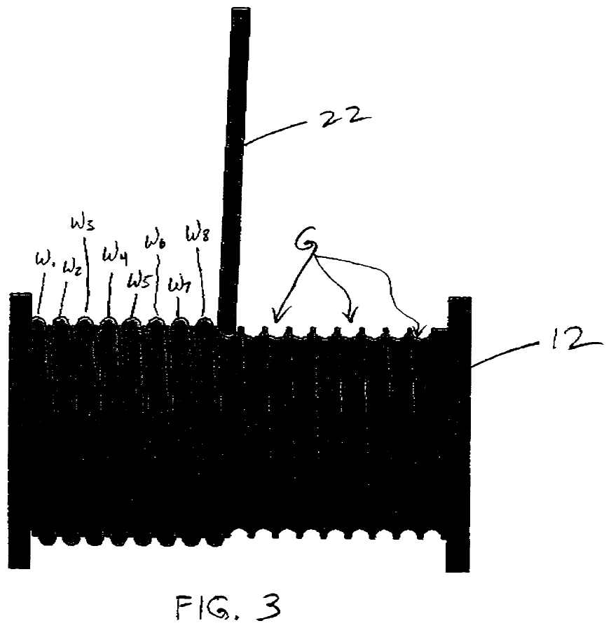

An illustration of the preferred embodiment is shown at FIG. 3. Spool 12 is shown with windings w₁-w₈ wound around it. In the position shown in FIG. 3, the cable 22 is shown as partially wound (i.e. partially retracted). The remainder of cable 22 is hanging down through an opening in the motor assembly (the motor, housing, and cable opening of the motor assembly are not shown in FIG. 3). The guide features G are also shown.

In the illustrative example of FIG. 3, the spool 12 has guide features in the form of a spiral groove G along its width that guides cable 22 so that each winding W is formed adjacent to, and not on top of, the previous winding, as the cable 16 is wound.

It is believed that this configuration will reduce the energy required for the motor to lift the patient, because the diameter of the spool-cable combination does not increase as the cable is wound progressively further.

It will be appreciated that, depending on a variety of factors (including, for example, the diameter of the spool and the width of the spool), it may be that one or more windings of the cable 16 that will be positioned over previous windings, and such a configuration is comprehended by the invention. For example, if the spool 12 is thick enough and wide enough to accommodate only X windings worth of cable, but the functional length of the cable comprises a length forming more than X windings, there may be windings positioned on top of previous windings.

What is important in this embodiment is that the spool-cable assembly be sized and shaped to reduce the extent to which the spool 12 with windings on it increases in diameter, by positioning multiple windings laterally relative to previous windings, and not on top of them. Thus, a configuration as shown in FIG. 3, but with two or more layers of windings one atop the other when the cable is fully wound, is comprehended by the invention. Such a configuration is an improvement over a strap which is wound repeatedly over itself in a spiral configuration, as shown in FIG. 2.

The cable may take the form of round steel wire with 5 mm thickness, which has a break-strength of 3200 pounds, or about 1455 kg. This is well above the 625 pound rating of a typical patient lift, and yet, the wire is quite thin. Thus, many windings of such wire can be positioned beside one another in a moderately sized spool.

The preferred wire can be used with a PVC sheath. This would allow for better and easier disinfection of the wire, as compared with prior art straps. The ability to disinfect adequately is beneficial, given that these lifts are often used in hospital and other similar environments.

A disadvantage of using steel wire is that steel wire has limited bending capability. Thus, using steel wire requires a minimum spool radius—if the radius of the spool is too small, the steel wire will not be capable of bending sufficiently to be wound around such the spool.

To get around this disadvantage, the lift may instead use a thin fibre rope, having a round, or rounded, cross-sectional shape. It will be appreciated that fibre rope will typically have substantially better bending capability than steel wire. Thus, it can be used on spools having a smaller diameter, which would save space within the lift.

Although various types of rope may be suitable, an example of a rope believed suitable for this purpose is HMPE (high molecular weight polyethylene) or UHMPE (ultra HMPE). Such fibre rope is available commercially with a vinyl-based coating to enhance durability. It is also available at small diameters with high breaking strength. For example, such rope is commercially available at a 5 mm diameter with a minimum breaking strength of 4450 lbs. As another example, such rope is available with a 6 mm diameter at a breaking strength of 7950 lbs (minimum). One source of such rope is Teufelberger Fiber Rope Corporation of Fall River, Mass., USA, under the Endura 12™ brand.

Another example of rope believed to be suitable for this application is Liquid Crystal Polymer (LCP) rope. Such rope is available from Yale Cordage of Maine, USA with, for example, a diameter of 6 mm rated for a “maximum working load” of 1000 lbs, and a minimum breaking strength of 4500 lbs. 5 mm LCP rope from the same source is rated with a minimum break strength of 2700 lbs and a “maximum working load” of 600 lbs.

Another example of rope believed to be suitable for this purpose is Ultrex™ brand rope from Yale Cordage. 4 mm Ultrex™ rope is rated with a minimum spliced break strength of 3060 lbs and “maximum working load” of 600 lbs.

As stated above, a recurring problem with patient lifts is wear on the strap. Because the lift is not always positioned directly vertically over the patient, the strap is often angled as it emerges from the lift. This angling is a particular problem when it occurs so as to press the edge of the strap against the edge of the slot in the lift device from which the strap emerges. As a result of such angling, the edge of the strap starts to fray, and must be replaced frequently to avoid breakage. The use of a long narrow opening is required in order to keep the strap from twisting and tangling.

In the preferred embodiment described above, a round wire is used instead of a strap. With the use of a round wire, smooth stainless steel or ceramic eyelets can be formed in the opening of the motor assembly housing from which the wire emerges. It would not be necessary to use a long narrow opening and thus, the opening could be shaped so as to be smooth, thus reducing wear on the wire. It will be appreciated that, even apart from the eyelets or other shaping to reduce wear, a round cable is more resistant to wear in these circumstances than a fabric strap. This greater resistance comes both from the fact that the cable is made of steel (in the steel wire embodiment), and the fact that it is round, and thus has no edge that is prone to fraying.

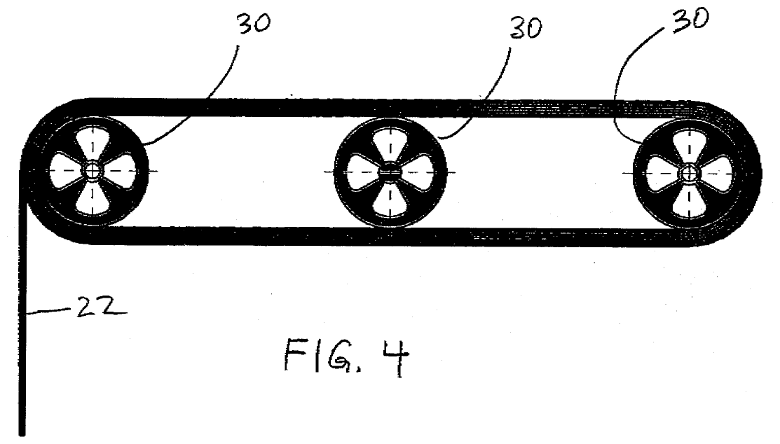

Other configurations may be employed to reduce the extent to which the diameter of the spool increases as the lifting element is wound. For example, as shown in FIG. 4, instead of a single spool, a plurality of rotors 30 can be used to wind the lifting element, in a configuration similar to a conveyor belt. FIG. 4 shows three rotors, but other numbers (e.g. two rotors) are also comprehended. The rotors turn to wind or unwind the lifting element, and the element is wound around the outside of both rotors. It will be appreciated that the use of multiple rotors causes more rope to be taken up by each winding. Furthermore, the further apart the end rotors are, the more rope is taken up by each winding. So, for example, in the practical spatial circumstances of a lift, it might be possible for the entire range of the lifting element to be wound up in about 2-3 windings. The result would be that, although the windings are positioned one atop the other, with the attendant increase in diameter, there are few windings, so the increase is small, and the torque demand on the motor remains fairly stable.

It will be appreciated that the multiple-rotor embodiment could be combined with the adjacent-winding embodiment described above. For example, the guide features G could be formed on the rotors, so that the windings are positioned adjacent rather than on top of one another on the rotors themselves.

Current lifts often need to be charged, because they operate on batteries. Users often forget to charge the lifts, and then they are unavailable when needed. The reason batteries are used is that, due to the high torque required for the motor, without batteries, large power supplies would be required which cannot be effectively contained within the lift device. A typical amount of current drawn by electric motors for patient lift devices is 25 A. However, with the reduced torque requirements resulting from features described above, a 10 amp motor might suffice. In such a case, a smaller DC power supply, which could be contained within the device, would be effective. Thus, batteries and charging would not be required. No battery replacement would be required, and the running cost of the lift would be lower. Alternatively, batteries that are charged might continue to be used, but they could be smaller and be charged much faster than in prior art configurations.

In another aspect of the invention (which may be implemented with or without the aspects of the invention described above), the lift preferably has a gesture-based or haptic control features as described in more detail below.

As mentioned above, patient lifts typically use a control console, in the nature of a handset, for causing the lift device to lift or lower the patient. Sometimes the handset can also be used to cause the device to move laterally along the track. Because of safety concerns, patient lifts operate on the principle that the lift only moves when the controller is activated, and stops when controller activation stops. So, to lift a patient, the user needs to keep the “up” button pressed until the lifting is complete. When the button is released the lift stops moving. As a result, the operator (typically a caregiver) only has one hand available for the patient as lifting is occurring. Sometimes, when the patient is lifted, he/she may swing or rotate, and it would be desirable for both hands to be available to stabilize the patient.

In the preferred embodiment, the caregiver would cause the lift to raise or lower the patient by gestures, such as force-applying gestures. Thus, for example, the caregiver may push down on the patient's shoulders, or on the carry bar, or pull down on the harness, and as long as that downward force is maintained, the patient lift would lower the patient. Similarly, the caregiver may pull up on the harness, or the carry bar, or on the patient himself, and the lift will start lifting, and continue to lift, the patient, until the upward force ceases to be applied.

Preferably, this functionality would be achieved by use of one or more load sensors. Most preferably, there is one force or load sensor and it is associated with the carry bar. It will be appreciated, however, that the load sensor(s) can be placed anywhere where they can sense the loading, unloading, and transition from loading to unloading or vice versa, of the patient lift.

Once the patient is in the harness and the lift is loaded, the device would sense the load, and balance/tare its load sensor. Then, to move the patient up, the user can push/pull upward on the harness, the carry bar, or the patient. The device would sense the slight unloading, recognize the gesture, and lift the patient until the user stops the gesture To lower the patient, the user can pull down on the harness or the carry bar (or push down on the patient's shoulders). The device would sense the slight extra loading, recognize the gesture, and lower the patient until the user stops the gesture.

In the preferred embodiment, the lift and load sensor(s) can be configured so that the lift raises or lowers the patient faster in response to a greater force, and more slowly in response to a lesser force.

In some embodiments, the load sensor can comprise a multi-axis load sensor operating along two or more axes. Such a load sensor can also be configured to sense a lateral force. Thus, by pushing against the patient laterally, or against the carry bar laterally, the user can cause the motor to move the patient laterally in one or the other direction along the track. Haptic or gesture-based control of lateral movement can also be implemented with an additional sensor or sensors, beyond the sensor used for vertical movement. For example, such an additional sensor could be positioned on the carry bar, so that the user pushes on that portion of the carry bar to cause lateral movement of the lift along the track.

One safety requirement that is often ignored due to user impatience is that when the lift is not in use it should be left at its highest position, so that people will not bump their heads on it or get tangled up with it as they walk around. As part of the controller described herein, the lift device may have a signal or user input (e.g. tapping thrice on the carry bar) that causes it to lift all the way to the top when unloaded. This signal or user input could be sensed using the load sensor described herein, or another sensor positioned elsewhere on the lift to sense the signal or other user input.

Also, the lift may need to be docked at the end of the track, where the charger is, to charge, but this is often forgotten or not done due to impatience, with the result that the lift is not available when needed. Another signal to an unloaded device (e.g. a certain number of taps) can be used to cause the lift to automatically move to the charger.

The use of gesture-based or haptic controls as described herein is believed to provide a number of benefits, including one or more of (1) the caregiver's hands can now be used to stabilize the patient, even as the caregiver's hands are also controlling movement; (2) the lift will be charged and stored out of the way more often; and (3) there will be time saving for the caregiver.

In the preferred embodiment, the patient lift includes an electronic or processor-based controller to facilitate haptic or gesture-based control in cooperation with the one or more force sensors or load cells. As described in detail below, the preferred lift includes features to facilitate the smooth and effective use of haptic/gesture-based control of the lift.

Initially, prior to the use of the lift, the value of the force sensor output is read. Then, a calibration procedure is carried out to convert the sensor output to a force value. Upon starting the lift, the carry bar is usually in midair, and not loaded with any patient weight. Thus, the initial sensor output value is read to define an “unloaded system bias,” The unloaded system bias is the sensor output value when the lift is unloaded, and the operator is not pushing upward or downward to activate the lift to move up or down. The key purpose of calculating the unloaded system bias is to allow the system to determine if the operator is applying a slight upward or downward force to move the lift up or down. So, for example, if the unloaded system bias is 2 volts (i.e. with the lift unloaded, and no operator input, the sensor outputs 2 volts), and then the controller gets a 2.1 volt reading from the sensor, the controller will know that the operator is exerting a slight force on the lift to cause it to move up or down (assuming 0.1 volts exceeds the relevant threshold value—see below). The bias value is preferably calculated by taking multiple measurements rapidly (e.g. 100 measurements in one second) and then averaging those measurements to calculate the bias. In this way, a statistically valid and accurate measurement of the bias is obtained.

Later, when a patient is fully suspended in the air by the lift, the sensor output value can be read again to define a “loaded system bias.” The loaded system bias is the sensor output value when the lift is fully loaded by the patient's weight and the operator is not pushing upward or downward to activate the lift to move up or down. The key purpose of calculating the loaded system bias is to allow the system to determine if the operator is applying a slight upward or downward force to mime the lift up or down. So, for example, if the loaded system bias is 3 volts (i.e. with the lift loaded, and no operator input, the sensor outputs 3 volts), and then the controller gets a 3.1 volt reading from the sensor, the controller will know that the operator is exerting a slight force on the lift to cause it to move up or down (assuming 0.1 volts exceeds the relevant threshold value—see below). The bias value is preferably calculated by taking multiple measurements rapidly (e.g. 100 measurements in one second) and then averaging those measurements to calculate the bias. In this way, a statistically valid and accurate measurement of the bias is obtained.

It has been found that the difference between the unloaded system bias and the loaded system bias is proportional to the weight of the particular patient. So, for example, if the aforementioned difference is 1 volt for a 50 kilogram patient, it would be approximately 2 volts for a 100 kilogram patient. Therefore, it is possible to use the present lift with the controller as a scale to weigh patients.

For reasons that will be described below, it is beneficial for the controller to determine whether the patient is fully or partially resting on a surface, or if the patient is fully suspended in the air. At any time, the system can compare the measured force against the system biases to determine which of these states the patient is in. The two system bias values are recalculated on each automatic loading or unloading transition (described further below).

The sensor outputs and resulting force signals are preferably smoothed using a low pass filter or other signal smoothing means. Filtering is employed to ensure that the signal remains stable, and only changes in response to sustained changes in force. Also, the smoothing and filtering creates a delay between when the operator applies a force, and when the application of force is registered by the control system. Thus, in this embodiment a small force is sufficient to initiate motion, but that small force must be sustained, at least for a brief period, before the control system initiates to move the lift. This feature is preferred because it helps ensure that the system is engaged by deliberate application of force, rather than an accidental, minor or unintentional application of force.

The system (preferably the controller) then assigns threshold force values that trigger the haptic control system. Preferably, the threshold force values vary depending on whether the lift is loaded with the patient, or is unloaded. If the lift is unloaded, preferably a smaller threshold is determined so that the carry bar (which is the preferred location for the operator to apply force) responds to smaller force inputs from the caregiver. If the lift is loaded with the patient, it is preferred to assign a higher threshold force, so that the haptic controller will not respond to slight changes in force due, for example, to patient movement. It is preferable for the lift not to begin lifting or lowering the patient simply because the patient shifted his/her weight in the patient harness.

The system (preferably the controller) checks for conditions that trigger automatic loading or unloading by the control system. In certain circumstances, described below, automatic loading or unloading by the control system is required because, at least in some embodiments, there is only one load sensor in the load path. Thus, when there is a transition from the patient resting on a surface to being partially lifted by the lift, the force sensor signal reflects a change in force that is due both to the force applied by the caregiver and the force applied on the lift apparatus by the patient. It is also possible that the caregiver merely wants to reposition rather than lift and move the patient. Thus, it is hard to tell whether the change in force being sensed is the result of the patient's weight, or the caregiver's input. As a result, the system has no clear answer as to how the lift should respond to the change in sensed force during a transition period. The same problem presents itself as a patient is lowered from a fully suspended position so as to be partially resting on a surface. Thus, preferably, the lift is configured to move in a predetermined way based on whether certain loading or unloading logic triggers are satisfied, as described further below.

By automatically moving a patient either up or down (i.e. regardless of input from the operator), the system can ensure that the patient is either fully resting on the surface (e.g. bed, chair) or fully lifted off the surface. Once in either of those states, it is possible, and most safe, for the system to assume that any force changes sensed by the load cell correspond to forces applied by the caregiver to move the lift up or down.

In one embodiment, to determine whether automatic unloading should be triggered (that is, if the condition is met, the lift is moved down until the patient is fully resting on the bed or other surface), the lift should be loaded, and the measured force found to be significantly less than the expected force the system should observe when fully loaded. This check is implemented via a set of logical comparisons involving the measured force, the last known system bias, and the loaded system bias.

In the preferred embodiment, to determine whether automatic loading should be triggered (that is, if the condition is met, the lift is moved up until the patient is fully suspended above the bed or other surface), the lift should be unloaded, and the measured force should be significantly higher than the expected force the system would expect to observe when fully unloaded. This check is implemented via a set of logical comparisons involving the measured force, the last known system bias, and the loaded system bias.

The system then checks whether the loading or unloading triggers were satisfied. If yes, the haptic control is suspended, and the lift either moves up (automatic loading) until the lift is fully loaded with the patient or partially loaded with the patient weight and the patient is sufficiently raised above the surface to enable a transfer from the surface; or down (automatic unloading) until the lift is fully unloaded. After the lift stops, a brief period is allowed to pass to permit the patient to stop moving, and for the force signal to settle down if it is oscillating. Thereafter, the relevant system bias is recalculated, and the values of both the unloaded system bias and loaded system bias are updated accordingly. The system can then keep track of whether the patient is on the resting surface (i.e. fully resting on the bed, chair etc.), or fully suspended in the air.

As mentioned above, the situation where automatic loading is triggered can initially resemble a situation where the user merely desires to reposition the patient on a bed (e.g. move from lying on back to lying on side), rather than lift the patient off of the bed. In repositioning, the patient is lifted slightly off of the bed to permit the change of position, and then lowered again. Practically, a repositioning harness is different from a lifting harness, and the orientation of the patient's body in each case is correspondingly different. Thus, preferably, the controller can distinguish between repositioning and lifting, so that when the patient is lifted for the purpose of repositioning, full automatic loading is not triggered.

In both cases, as the patient is lifted off of the surface, there is a force profile, consisting of the output of the load sensor over the time that the patient is moving from being fully resting on the bed to being slightly off of the bed (i.e. not fully resting on the bed). It has been found through testing that the force profile for repositioning is distinct from the force profile for lifting. The required data regarding the force profile is stored in the controller or associated memory. Thus, the controller preferably determines based on the force profile if repositioning is occurring, and if so, full automatic loading is not triggered.

Rather, if the controller force profile for repositioning is detected, automatic repositioning loading is triggered by the controller, which loading involves only a slight lift of the patient above the bed or other surface. The nature of the repositioning harness generally used for repositioning is that this slight lift will typically cause the patient to roll onto his/her side. Then, automatic repositioning unloading is initiated by the controller to rest the patient back on the bed or other surface.

If the loading and unloading triggers are both not satisfied, and there is therefore no transition, the lift is in normal haptic operating mode, and the measured force is compared against the threshold values referred to above. If it is determined that the measured force, less the last known relevant system bias, is larger than the relevant threshold value, this is interpreted as the caregiver pushing down on the patient/carry bar/harness, and the lift moves down. If it is determined that measured force less the last known relevant system bias is smaller than the negative value of the threshold, this is interpreted as to the caregiver applying an upward force, and the lift is moved upward. Lift motion continues so long as the threshold is exceeded. If the threshold is not exceeded in either direction, this is interpreted as a command to hold the patient still.

Thus, the use of threshold force values keeps the system relatively steady and ensures that small fluctuations in force due to light touch by the caregiver or motion by the patient do not mistakenly activate the lift. Notably, in the preferred embodiment, this control feature is only active when the system is not in an automatic loading or unloading condition.

In the preferred embodiment, there are other motion limits imposed by the system during the haptic control phase (i.e. when automatic loading or unloading is not triggered). When the haptic system is active, and the force drops below the threshold, the preferred system keeps the lift in motion in the same direction for a predetermined brief period. In addition, once the lift stops, there is a short delay before the haptic system can be reactivated to move in either direction. Forcing the lift to continue moving in the same direction for a brief period, and then forcing a pause, helps to ensure that the automatic loading and unloading triggers are properly activated when they should be. Without these motion limits, the loading or unloading of the lift during a transition may “fool” the control system into moving the lift in the wrong direction. For example, when a patient is being lifted off of a bed, the increase in the patient's loading of the system eventually exceeds the force the caregiver applies to move the patient up. Without the aforementioned motion limits, the automatic loading trigger would not be activated until the caregiver applies an excessively large force upwards to initiate the motion.

In an alternative embodiment, the need for transition states as described above could be reduced or eliminated by, for example, adding another force sensor, not on the load path of the lift. The sensor could be configured or positioned to measure only the haptic force exerted by the operator on, for example, the carry bar. This would allow for haptic control effective even during transition states. However, a disadvantage is that the haptic force would have to be applied specifically at the operative area of the additional sensor—e.g. at the specific point on the carry bar where the sensor operates. That area may be inaccessible in certain situations. Further, when using that additional sensor the operator could not place his/her hands on the patient to lift and lower the patient, as the sensor is not operative on the patient himself.

In another aspect of the invention, the apparatus detects improper or unsafe coupling of the harness to the lifting element, typically in the form of harness loop migration. Harness loop migration refers to a situation in which the loops of the harness by which the harness hangs from the carry bar are improperly positioned so that it is actually unsafe to lift a patient. Typically, the harness has four loops, two positioned at or near one end of the carry bar, and two positioned at or near the other end, with the point of connection of the lifting element (e.g. cable, strap) to the carry bar being between them at the centre of the carry bar. Occasionally any of the loops will migrate out of the carry bar hooks, and may slip off of the bar, either before or during lifting. In such a case, when the patient is lifted, and when the loop slips off of the bar, the patient will be unbalanced, as will the carry bar. This creates an unsafe situation and patient can slide through the unbalanced sling.

Because of the lack of balance in the harness and the carry bar, the patient will tilt and swing relatively rapidly when being lifted in a situation of unsafe harness migration. It has been found that in such a case, the single load sensor in the load path of the lift will register rapid changes in the force sensed as a patient is lifted in this situation. It will be appreciated that the lift usually shows a range of rates of change of sensed force when operating in safe conditions without harness migration. It has been found that in the unsafe condition being described here, the rate of change of sensed force is higher than in safe conditions, indicating harness loop migration and an unsafe lifting condition. Preferably, through testing, a predetermined rate of change of sensed force threshold is determined. If during lifting, that threshold is exceeded, the controller immediately stops lifting, and preferably, performs emergency lowering of the patient back to the surface from which he/she was being lifted.

It will be appreciated that automatic harness migration detection is beneficial in that the lift does not rely on the caregiver's alertness or state of mind, but rather, detects this unsafe condition automatically.

Alternatively, harness loop migration can be sensed by means of a separate sensor in the carry bar, distinct from the single load sensor in the load path referred to above. The carry bar sensor can be used as an angle sensor. It may comprise a gyroscope. If the carry bar is angled too far from the horizontal during lifting, beyond a predetermined threshold, the harness migration condition is sensed, the controller immediately stops lifting, and preferably, performs emergency lowering of the patient back to the surface from which he/she was being lifted.

Alternatively, harness loop migration can also be sensed by means of a visual sensor in the lift or vicinity of the lift, distinct from the single load sensor in the load path referred to above. The visual sensor can be used as an angle sensor to measure and monitor the angle of the carry bar. It may comprise a camera, a radar or a Lidar.

If the carry bar is angled too far from the horizontal during lifting, beyond a predetermined threshold, the harness migration condition is sensed, the controller immediately stops lifting, and preferably, performs emergency lowering of the patient back to the surface from which he/she was being lifted.

In the preferred embodiment, the controller provides two modes for same of the basic functions of the lift, including for example the automatic loading and unloading described above. The first mode is automatic with a time delay, and the second mode provides for a pause for user input. In effect, the first mode is action-biased, with a pause to permit the user to rescind the action. The second mode is status quo biased, requiring a final user input to initiate action.

For example, as described above, the automatic loading sequence of the lift in the first mode would involve a time delay prior to the lift automatically lifting the patient. The time delay (e.g. three or five seconds), would permit the caregiver to make sure that the automatic loading sequence is desirable and safe (e.g. visual check for harness migration, patient properly fastened in harness, patient not tangled in anything). If the caregiver wants to stop the automatic loading, he can provide a stop input (e.g. tugging on the cable or other lifting element, tapping on the carry bar etc.). However, in the absence of intervention from the caregiver, the automatic loading would commence after the time delay. This concept applies mutatis mutandis to automatic unloading, and to other functions of the lift.

Using automatic loading as an example again, in the second mode, when the conditions for automatic loading are met, the lift would pause indefinitely and await a final action input from the user (e.g. tug on lifting element, tap carry bar etc.). This concept applies mutatis mutandis to automatic unloading, and to other functions of the lift.

As mentioned above, for automatic loading and unloading, the patient's weight is calibrated as part of the process of automatic loading and unloading, and of determining the loaded system bias. As an alternative to the automatic calibration of the patient's weight, the controller can be configured to calibrate the patient's weight in response to a calibration input by the user (e.g. pushing a button, tugging on the lifting element a predetermined number of times, etc.). This comprises an example of the two modes referred to above.

As a safety measure, many users prefer to lift the patient only a few centimeters (say, 8-12 cm) off the bed or other surface before moving them laterally. Another benefit of limiting the lift to a small distance off the bed is that the patient is less likely to be frightened. Thus, when the conditions for an up transition are met, the lift may only raise the patient about 8-12 cm. At that limited height, the patient's bottom would typically be about 8-12 cm off the bed, but the patient's feet would typically still be resting on the bed. Thus, to calibrate the patient's weight accurately, it would be necessary to rotate the patient so that his/her feet are off the bed, and he/she is completely suspended. This feature permits the caregiver to do that, as described above.

The controller itself maybe used to limit lifting to only a predetermined small distance off the bed, such as for example 8-12 centimeters. The controller can measure the rate of change of the load being borne by the lift as the patient is lifted. When that rate of change approaches zero, it means that the patient has been substantially lifted off the bed, though the patient's feet, for example, may still be resting on the bed, as described above.

It will be appreciated, however, that even without the rate of change of load being near zero (e.g. the patient is kicking or twisting in the harness), the lift may still limit the height as described above for increased safety and patient comfort.

In accordance with the first mode referred to above, the lift may inform the caregiver or user that it will calibrate the lift with the patient's weight, and then proceed to do so unless interrupted by the user. For example, after it is determined that the patient is substantially off of the bed, the controller may use a voice prompt to inform the user that the weight will be calibrated in a fixed period of time—say, five seconds. In this scenario, the user would have five seconds to rotate the patient so as to move her/his feet off of the bed to permit accurate calibration

It will be appreciated that even with the safety features described herein, it may be that as the lift is transitioning upward and lifting the patient off the bed, the upward lifting needs to be overridden for safety reasons in particular circumstances. Preferably, the user can input, and the controller can receive, a lift interrupt to interrupt the lift sequence which is happening automatically. The lift interrupt can take any feasible form, such as, for example, a particular predetermined number of tugs on the lifting element, or a particular predetermined number of taps on the carry bar. Other example ways of sending a lift interrupt include pushing a button on a handset, or pushing a button on the lift housing.

In response to the lift interrupt signal initiated by the user, the controller may either stop the lift in place, so that further action may be taken by the user. Alternatively, the controller may cause the lift to return to its pre-lift position automatically in response a lift interrupt signal from the user. It is believed that stopping in response to a lift interrupt signal is preferred, as continuing to move, even in the opposite direction, may exacerbate whatever unsafe condition may exist. By stopping the lift completely, the user can attend to the unsafe condition before, for example, manually lowering the patient to remove him/her from the harness. However, it is also believed that in some operating environments, it would be preferred to have the patient be automatically lowered in the event of a lift interrupt signal.

As another safety feature, during lowering of a patient, the controller may lower the patient and continue lowering until the carry bar touches the patient or comes to rest on the patient. It will be appreciated that, given the height taken up by the harness when the patient is suspended, if the lift lowers until the carry bar reaches the patient, then there is greater certainty that the patient has actually has come to rest on the bed or other surface.

It will be appreciated that the controller can sense that the carry bar is resting on the patient. When the system determines the unloaded system bias (see above), it does so with the lift unloaded by the patient. However, in the preferred embodiment the carry bar is suspended from the lifting element when the unloaded system bias is determined. Therefore, when the lift lowers until the carry bar comes to rest on the patient, and is no longer suspended, the load sensor will produce an output below that of the unloaded system bias, thus indicating that the carry bar is resting on the patient.

Once the carry bar has reached the patient, providing greater certainty that the patient is properly positioned on the bed or other surface, and its positioned is sensed by the load sensor's output, there are at least two alternatives for the lift. One, the lift can automatically lift the carry bar until the load sensor output is no longer less than the unloaded system bias, meaning that the carry bar is again suspended and not resting on the patient. Two, the lift can automatically raise the carry bar a fixed amount (say, 5 cm or 10 cm) to move the carry bar off the patient. The patient can then be disengaged from the lift and left resting on the bad or other surface.

Preferably, the controller and associated electronic memory provide voice prompts. In this embodiment, the lift includes a speaker to produce audible voice prompts stored in the memory. The voice prompts may be used to prompt the user to take actions, to notify the user that he/she may be take an action if desired, and to notify the user that the lift will automatically carry out an action. For example, voice prompts may prompt the user to take actions involving the safety of the patient, such as checking to see that the patient is properly fastened into the harness, and that the harness is properly mounted to the carry bar or lifting element. It may prompt the user to tug downward once on the lifting element, carry bar or patient to actuate lifting or some other action.

In a mode where the lift automatically lifts or lowers unless interrupted by a user, the voice prompt may tell the user something like “the patient will be lifted in five second—tug down on carry bar to interrupt.” If other signals are used to interrupt, the voice prompt would be modified accordingly.

It will be appreciated that the more the use of the lift can be safely done by following voice prompts, the training requirement associated with the lift are reduced. Specifically, there is less of a requirement to teach a user in advance how the lift functions, because at each stage of use, the lift would prompt the user as to the next step that the lift would carry out, or that the user needs to carry out.

In one embodiment, the controller includes a voice recognition module for accepting voice commands from tho user. Instead of haptic or gestural inputs as described above, the controller may accept predetermined voice commands instead of haptic and gestural inputs to operate the lift.

It will be appreciated that embodiments of the lift described herein have the benefit of being usable by a single caregiver. Because various actions of the lift are initiated gesturally or by haptic input, the caregiver can keep both hands on the patient for safety, while simultaneously actuating the lift to lift and lower the patient, and move the patient laterally, as desired.

In one embodiment, the lift and its controller may be connected to the internet and to a custom-configured cloud service. The connection to the internet may achieved through a variety of means including a wired connection, wireless connection via a Wi-Fi module built into the electronics, or via a wireless communication through technologies such as Bluetooth or SigFox to a base station or gateway module that then directs the received information to the cloud service via the internet.

The lift's connection to the internet may be used for unidirectional or bi-directional communication to the cloud service and may allow for features such as monitoring of lift usage, automatic reporting of safety concerns and issues such as loop migration, collection of measurements of lift state to enable preventative maintenance algorithms (e.g., early detection of a failing battery that requires replacement). Bidirectional communication may be of interest as well, enabling features such as the ability to change the controller's firmware remotely, the ability to change various operating parameters of the lift remotely (e.g., regulating or limiting the maximum allowable speed of lifting), and the ability to provide feedback to user and patients in some situations (e.g., a request for help may be submitted via this connection interface, and furthermore, a response from the individual who may assist can be provided back to the user and patient). The communication via the internet with the cloud service may also allow for acquisition and use of voice prompts (mentioned above) not stored in memory. Thus, the voice prompts may be added to or improved over time by means of communication with the cloud service.

It will be appreciated that the preferred lift disclosed herein uses a combination of features to control and enforce the process by which patients are lifted, lowered and transferred, to increase safety. Voice prompts can prompt the user to take certain actions, such as check for safe conditions (e.g. harness safety). In the two modes described above, automatic loading and unloading may either require a final user input, or may have a delay prior to the action. In either case, a voice prompt may be used to inform the user of what is required or what will happen next (depending on the mode selected by the user). Also, the delay or requirement for input makes it more likely that the user will check harness safety in response to the voice prompts.

It will be appreciated that, although not preferred, the invention comprehends the use of voice prompts as described herein, together with ordinary input from, say, a hand-held control console (rather than haptic inputs described in detail herein). Thus, voice prompts together with, for example, traditional button-pushing lift control consoles may be used. The button inputs (or other non-haptic inputs) could be used to move the user up and down. Data from the load sensor described herein could be used by a controller to automatically stop the lift in an unsafe situation, or to initiate a voice prompt to warn a user about an unsafe situation. Thus, even without haptics, some features described herein can improve user and patient safety.

It will be appreciated by those skilled in the art that the invention is not limited to the particular detailed description. Rather, the invention is to be interpreted and having the full scope of the disclosure.

1. A patient lift device for lifting and lowering a patient, the lift device comprising a motor assembly including a motor for generating lifting force, a harness for holding the patient, and a lifting element operatively connected to the motor and the harness, the motor assembly further comprising a spool operatively connected to the motor for winding and unwinding the lifting element to lift and lower the patient, the spool and lifting element being configured so that as the lifting element is wound on the spool, successive winds are positioned on the spool adjacent to one another.

2. A patient lift as claimed in claim 1, wherein the lifting element comprises metal wire.

3. A patient lift as claimed in claim 1, wherein the lifting element comprises fibre rope.

4. A patient lift device for lifting and lowering a patient, the lift device comprising a motor assembly, a lifting element operatively connected to the motor assembly, and a harness operatively connected to the lifting element for holding the patient to be lifted and lowered, the lifting element and harness defining a load path along which a patient lift load is transmitted to the motor assembly, the device further including a load sensor along the load path configured to sense the load on the motor assembly, the device further including a controller, operatively connected to the load sensor and the motor assembly, for controlling the motor assembly, and for using an output from the sensor to cause the motor to lift the patient when an operator exerts an upward force on the patient or on the load path so as to reduce the sensed load, and to lower the patient when the operator exerts a downward force on the patient or on the load path so as to increase the sensed load.

5. A patient lift device as claimed in claim 4, the device further including a carry bar to which the lifting element is connected and which carries the harness, the carry bar being positioned on the load path, the load sensor being positioned on the carry bar.

6. A patient lift device as claimed in claim 4, wherein the controller is further configured to initiate an automatic loading sequence when the lift is in a transition state between the patient fully resting on a surface and the patient being fully suspended, the automatic loading sequence comprising the lift automatically moving up regardless of haptic input to cause the patient to be fully suspended.

7. A patient lift device as claimed in claim 4, wherein the controller is further configured to initiate an automatic unloading sequence when the lift is in a transition state between the patient fully resting on the surface and the patient being fully suspended, the automatic unloading sequence comprising the lift automatically moving down regardless of haptic input to cause the patient to be fully resting on a surface.

8. A patient lift device as claimed in claim 4, wherein the controller further comprises a controller for identifying a force profile associated with repositioning of a patient, and for initiating automatic repositioning loading to turn the patient on the patient's side.

9. A patient lift as claimed in claim 4, wherein the controller further comprises a controller for initiating automatic repositioning unloading to rest the patient who has been turned on the patient's side on a patient resting surface.

10. A patient lift as claimed in claim 4, wherein the patient lift comprises harness imbalance detection for detecting unsafe coupling of the harness to the lifting element.

11. A patient lift as claimed in claim 10, wherein the harness imbalance detection comprises the load sensor.

12. A patient lift as claimed in claim 10, wherein the lift comprises a carry bar mounted to the lifting element and wherein the harness is mounted to the carry bar, and wherein the harness imbalance detection comprises a second sensor for detecting angling of the carry bar.

13. A patient lift as claimed in claim 12, wherein the second sensor comprises a visual sensor.
